(19) United States
(12) Patent Application Publication
(10) Pub. No.: US 2025/0197071 A1
(43) Pub. Date: Jun. 19, 2025

(54) THREADED PAPER LID FOR CONTAINER

(71) Applicant: Seda International Packaging Group SPA, Arzano Napoli (IT)

(72) Inventor: Gianfranco D'Amato, Arzano Napoli (IT)

(21) Appl. No.: 18/844,799

(22) PCT Filed: Mar. 9, 2023
(86) PCT No.: PCT/EP2023/056041

§ 371 Date: Sep. 6, 2024

(30) Foreign Application Priority Data
Mar. 9, 2022 (EP) 22161133.8

(51) Int. Cl. B65D 43/02; B31F 1/00; B65D 21/02

(52) U.S. Cl. CPC B65D 43/0231; B31F 1/0093; B65D 21/0219; B65D 2543/00092; B65D 2543/0024; B65D 2543/00268; B65D 2543/00296; B65D 2543/00527; B65D 2543/00537

(57) ABSTRACT

The present invention relates to a paper lid (3). The paper lid (3) comprises a central lid panel (7, 31) and a fitting flange (5). The fitting flange (5) is adapted to be arranged on a receptacle (2) of a container (1). The fitting flange (5) is made of paper material, wherein the fitting flange (5) forms a radially outer side (9) of the paper lid (3). A groove (11) is formed in the radially outer side (9) of the fitting flange (5) and the groove (11) forms a thread (13) on a radially inner side (15) of the fitting flange (5). The thread (13) is made of paper material. The invention further provides a container, stack of at least two containers and a method for producing a lid.

### CROSS-REFERENCE TO RELATED APPLICATIONS

This application is a National Stage of and claims priority to International Patent Application No. PCT/EP2023/056041, filed on Mar. 9, 2023, and European Patent Application No. EP 22161133.8, filed on Mar. 9, 2022, the contents of both of which are hereby incorporated by reference in their entirety.

### TECHNICAL FIELD

The present invention relates to a paper lid, in particular a paper lid for a container, and to a method for producing a lid for a container.

### BACKGROUND

WO 2010/147463 A1 discloses a screw cap with a threaded cylinder of essentially paper material. A layer of material is applied to the outer surface of the cylinder, wherein the layer of material does not comprise a thread or a groove.

WO 2021/037980 A1 discloses a lid with a fitting flange, wherein the fitting flange comprises an engagement protrusion.

GB 564 715 discloses to produce a composite flange or skirt, consisting of three paper plies or laminations. A continuous or interrupted screw thread is pressed into the flange or skirt.

GB 405 789 discloses a closure comprising a disc of paper. The periphery of the disc is turned down to form a flange. A screw thread is formed in the flange, wherein the screw thread is a protrusion on the outer side of the flange. Alternatively, it is disclosed to provide a groove in the outer surface of the flange.

Due to the ever increasing environmental sustainability issues, there is a need to produce environment-friendly lids.

### SUMMARY

According to a first aspect of the invention, a paper lid is provided. The paper lid may comprise a central lid panel. The paper lid may comprise a fitting flange. The fitting flange may be adapted to be arranged on a receptacle of a container. The fitting flange may be made of paper material. The fitting flange may form a radially outer side of the paper lid. A groove may be formed in the radially outer side of the fitting flange. The groove may form a thread on a radially inner side of the fitting flange. Optionally, the thread may be made of paper material. The thread may protrude by 0.5 millimeter to 2 millimeter over the inner side of the fitting flange, in particular by 0.7 millimeter to 1.5 millimeter, preferably by 0.7 millimeter to 1.2 millimeter. The groove may have a width between 1 millimeter to 3 millimeter, in particular between 1.5 millimeter to 2.5 millimeter.

The receptacle and the lid form together a container. The receptacle may be a jar or bottle.

The thread may be made of paper material. Thus, the paper lid and the thread may be fully recyclable, may be incinerated without producing harmful exhaust, or may be compostable.

The paper lid may be arranged, in particular nested, in a second paper lid to obtain a stack of two paper lids or a stack of more than two paper lids.

The fitting flange may have a reduced diameter at the end of the fitting flange, in particular where the central lid panel is connected to the fitting flange. This may allow to arrange, in particular to nest, a paper lid in a second paper lid to obtain a stack of two paper lids or a stack of more than two paper lids.

The diameter at the end of the fitting flange where the central lid panel is connected to the fitting flange may be smaller than a diameter at the end of the fitting flange opposite to the end of the fitting flange where the central lid panel is connected to the fitting flange.

The diameter at the end of the fitting flange where the central lid panel is connected to the fitting flange and the diameter at the opposite end of the fitting flange may differ in a range between 0.2 millimeter to 2 millimeter, in particular between 0.4 millimeter to 1.6 millimeter, preferably between 0.6 millimeter to 1.4 millimeter.

This may allow arranging, in particular nesting, a paper lid in a second paper lid to obtain a stack of two paper lids or a stack of more than two paper lids.

The respective diameters may be an outermost diameter of the fitting flange or an innermost diameter of the fitting flange.

The paper lid may be shaped to prevent a second paper lid to be introduced into the paper lid.

The fitting flange may be substantially cylindrical, in particular cylindrical. The fitting flange may have a constant outermost diameter over the length of the fitting flange, apart from local grooves formed in the fitting flange. The fitting flange may have a constant innermost diameter over the length of the fitting flange, apart from the thread and optionally a circumferential protrusion formed in the fitting flange. The innermost diameter may be in a range between 60 millimeter and 170 millimeter, in particular between 70 millimeter and 160 millimeter, in particular between 80 millimeter and 150 millimeter, in particular between 90 millimeter and 140 millimeter, in particular between 100 millimeter and 130 millimeter, in particular between 110 millimeter and 120 millimeter, in particular between 60 millimeter and 100 millimeter, in particular between 100 millimeter and 130 millimeter, in particular between 130 millimeter and 170 millimeter, in particular between 70 millimeter to 84 millimeter, in particular between 73 millimeter to 81 millimeter, preferably between 75 millimeter to 79 millimeter. The outermost diameter may be in a range between 60 millimeter and 170 millimeter, in particular between 70 millimeter and 160 millimeter, in particular between 80 millimeter and 150 millimeter, in particular between 90 millimeter and 140 millimeter, in particular between 100 millimeter and 130 millimeter, in particular between 110 millimeter and 120 millimeter, in particular between 60 millimeter and 100 millimeter, in particular between 100 millimeter and 130 millimeter, in particular between 130 millimeter and 170 millimeter, in particular between 71 millimeter to 85 millimeter, in particular between 74 millimeter to 82 millimeter, preferably between 76 millimeter to 80 millimeter.

An upper portion of the fitting flange may be connected by means of an adhesive to the central lid panel.

The adhesive may be provided by a hot melt coating on the central lid panel or the fitting flange.

The fitting flange may be sealed by a thermo-sealable varnish to the central lid panel. The thermo-sealable varnish may be provided on an outer side of the central lid panel or on an inner side of the fitting flange.

The fitting flange may be sealed by polyethylene to the central lid panel. The polyethylene may be provided on an outer side of the central lid panel or on an inner side of the fitting flange. The polyethylene may be provided on an outer side of the central lid panel and on an inner side of the fitting flange.

An upper portion of the fitting flange may be sealed by a thermo-sealable varnish to the central lid panel.

An upper portion of the fitting flange may be sealed by polyethylene to the central lid panel.

An upper portion of the fitting flange may be sealed by plastic material to the central lid panel.

The adhesive may be provided by a hot melt coating on an outer side of the central lid panel or on an inner side of the fitting flange.

The central lid panel may be arranged beneath the upper portion of the fitting flange. The central lid panel may be arranged beneath the upper portion of the fitting flange by 2 millimeter to 6 millimeter, in particular by 2.5 millimeter to 5.5 millimeter, preferably by 3 millimeter to 5 millimeter.

The adhesive may be provided by a hot made coating on an outer side of the central lid panel and on an inner side of the fitting flange.

In particular, the fitting flange and the central lid panel may be separate parts. This may allow to form the fitting flange independent from forming the central lid panel. In particular, the fitting flange may be optimized to fit to the size of the central lid panel. A distortion of the fitting flange or of the central lid panel may be prevented.

The fitting flange may be made of spirally wound paper material. The fitting flange may be in the form of a tube. A paper material may be wound to form spirally wound layers of paper material. Spirally wound layers of paper material may be staggered with respect to each other to overlap a discontinuity between the spirally wound layers of paper material.

The fitting flange may be made of only one layer of paper material.

The fitting flange may be made of several, in particular at least two or at least three, layers of paper material. The several layers of paper material may be glued to each other.

The fitting flange may have a constant thickness. The fitting flange may provide a constant material strength over the length of the fitting flange.

The fitting flange may have a thickness in the range of 0.5 millimeters to 1.2 millimeters.

The fitting flange may have a thickness in the range of 0.7 millimeters to 1 millimeter. The thickness of the fitting flange may provide paper material to form the thread. The fitting flange may provide a reinforcing layer for the thread.

A thickness of the central lid panel may be different from the thickness of the fitting flange. The thickness of the central lid panel may be less than the thickness of the fitting flange. A reduced thickness of the central lid panel may be used to reduce a material amount to form the paper lid.

An upper portion of the fitting flange may form a folded portion. The folded portion may receive an upwardly folded flange of the central lid panel.

An edge of the central lid panel may be configured as an engagement portion to engage the upper portion of the fitting flange. A connection between the fitting flange and the central lid panel may provide a liquid-tight assembly.

The folded portion may be flat on the radially inner side of the fitting flange. The folded portion may have a curvature on the radially inner side of the fitting flange. The folded portion may be flat on the radially outer side of the fitting flange. The folded portion may have a curvature on the radially outer side of the fitting flange.

The central lid panel and the fitting flange may be integrally made from the same sheet of paper material. An integral assembly between central lid panel and fitting flange may provide a seamless connection between the central lid panel and the fitting flange to provide a liquid-tight assembly.

The paper material of the fitting flange may be laminated with polyethylene. The paper material of the fitting flange may be laminated with polyethylene terephthalate. The paper material of the fitting flange may be laminated with polylactide. The paper material of the fitting flange may be laminated with polypropylene.

The thread may have symmetrical thread angles with respect to a normal direction of the fitting flange.

The thread may have asymmetrical thread angles with respect to the normal direction of the fitting flange.

The asymmetrical thread angles may comprise a steeper thread angle at its lower side than at its upper side. The asymmetrical thread angles may comprise a thread angle at the upper side of the thread in a range of 30 degrees to 50 degrees with respect to the normal direction of the fitting flange. The asymmetrical thread angles may comprise a thread angle at the lower side of the thread in a range of 5 degrees to 25 degrees with respect to the normal direction of the fitting flange.

Symmetric thread angles with respect to the normal direction of the fitting flange may provide more friction than asymmetric thread angles when screwing the paper lid on the receptacle.

An upper circumferential groove may be formed in the radially outer side of the fitting flange. The upper circumferential groove may form a circumferential protrusion on a radially inner side of the fitting flange. An insert panel may be arranged on the circumferential protrusion.

The circumferential protrusion may protrude by 0.5 millimeter to 2 millimeter over the inner side of the fitting flange, in particular by 0.5 millimeter to 1.5 millimeter, preferably by 0.5 millimeter to 1 millimeter. The upper circumferential groove may have a width between 1 millimeter to 3 millimeter, preferably between 1.5 millimeter to 2.5 millimeter. A lower portion of the fitting flange may be opposite to the upper portion of the fitting flange. A central plane of the circumferential protrusion may have a distance between 9 millimeter to 14 millimeter from the lower portion, in particular between 9.5 millimeter to 13.5 millimeter, preferably between 10.5 millimeter to 12.5 millimeter.

The thread may be arranged between the lower portion of the fitting flange and the upper circumferential protrusion.

The lower portion of the fitting flange may be separated from the upper portion of the fitting flange by 15 millimeter to 23 millimeter, in particular by 17 millimeter to 21 millimeter, preferably by 18 millimeter to 20 millimeter.

The insert panel may comprise paper material. The insert panel may be configured as a protection layer when screwing the paper lid on the receptacle. The insert panel may be configured to be connected to an opening edge of the receptacle. The insert panel may be arranged in between the opening edge of the receptacle and the central lid panel. The insert panel may comprise a cardboard panel. The insert panel may comprise an aluminum layer.

The central lid panel may have a stacking portion. The stacking portion may be bulged in an upper direction. The stacking portion may provide a surface for placing a bottle or a container on the paper lid. The stacking portion may provide a surface for placing substantially the entire bottom part of the receptacle on the paper lid, to provide a wiggle-free support for the container or the bottle. The stacking portion may be arranged beneath the upper portion of the fitting flange. The stacking portion may be arranged beneath the upper portion of the fitting flange by less than 5 millimeter, 1 millimeter to 4 millimeter, in particular by 1 millimeter to 3 millimeter, preferably by 1.5 millimeter to 2.5 millimeter. The stacking portion may be arranged, at least partly, in a range on a height level with the upper portion of the fitting flange to 5 millimeter beneath the upper portion of the fitting flange.

In particular, a surface of the stacking portion may be arranged in a range on a height level with the upper portion of the fitting flange to 5 millimeter beneath the upper portion of the fitting flange.

A container may be provided. The container may comprise a receptacle, such as a jar made of glass or a bottle made of glass. The container may comprise the paper lid. The receptacle may be a jar or a bottle made of plastic. The receptacle may be a jar or a bottle made of paper.

The container may comprise a receptacle. The receptacle may be made of glass. The receptacle may comprise paper material. The receptacle may comprise cardboard material. The receptacle may comprise plastic material. The receptacle may comprise plurilaminate material. The receptacle may comprise polylaminate material. The plurilaminate material or the polylaminate material may comprise multiple layers of material. The multiple layers of material may comprise paper material. The multiple layers of material may comprise plastic material or polyethylene. The multiple layers of material may comprise paper material and plastic material or paper material and polyethylene. The plurilaminate material or the polylaminate material may be a paper-based composite material. The plurilaminate material or the polylaminate material may be adapted to form a liquid-tight receptacle or a receptacle for food.

A stack of at least two containers may have the paper lid. A stack of at least two container may each have the paper lid. The central lid panel may have a stacking portion. The stacking portion may be bulged in the upper direction. The bottom of an upper container may be arranged on the stacking portion of the paper lid of the lower container.

The stacking portion may provide a surface to provide a wiggle-free support for at least the upper container.

The thread may be configured to engage or mate with a corresponding thread on a container, in particular on an outer surface of a container.

The central lid panel may be arranged vertically above the fitting flange. Vertically above may mean that when the lid is put onto a container that is placed on a horizontal support, according to its intended use, the central lid panel, in particular its center of gravity, is further away from the horizontal support than the fitting flange, in particular the center of gravity of the fitting flange.

The central lid panel may be arranged vertically above the thread. Vertically above may mean that when the lid is put onto a container that is placed on a horizontal support, according to its intended use, the central lid panel, in particular its center of gravity, is further away from the horizontal support than the thread, in particular the center of gravity of the thread.

The central lid panel may be arranged vertically above the groove. Vertically above may mean that when the lid is put onto a container that is placed on a horizontal support, according to its intended use, the central lid panel, in particular its center of gravity, is further away from the horizontal support than the groove, in particular the center of gravity of the groove.

The lid may have an upper end and a lower end. When the lid is placed on a container, according to its intended use, the lower end of the lid is closer to the container than the upper end of the lid. The central lid panel, in particular its center of gravity, may be closer to the upper end of the lid than the fitting flange, in particular the center of gravity of the fitting flange. The central lid panel, in particular its center of gravity, may be closer to the upper end of the lid than the thread, in particular the center of gravity of the thread. The central lid panel, in particular its center of gravity, may be closer to the upper end of the lid than the groove, in particular the center of gravity of the groove.

According a second aspect of the present invention, there is provided a method for producing a lid for a container.

The method may comprise providing a tube of paper material. The method may comprise cutting the tube into ring-shaped segments. The method may comprise connecting a ring-shaped segment with a central lid panel. The method may comprise forming a thread in the ring-shaped segment. The aforementioned steps may be executed in the order as listed or in any other order.

The method may comprise forming a circumferential groove in the ring-shaped segment.

The circumferential groove may be formed in a separate step from forming the thread in the ring-shaped segment.

The method may comprise forming the circumferential groove in the ring-shaped segment along with forming the thread in the ring-shaped segment.

According to a third aspect of the invention, there is provided a system comprising a lid according to the first aspect of the invention and a container. The lid may be configured to engage or mate with the container. In particular, the thread of the lid may be configured to engage or mate with a corresponding thread of the container, in particular on an outer surface of the container.

In particular, an inner surface of the thread of the lid may be configured to engage or mate with the container, in particular with a corresponding thread of the container, in particular on an outer surface of the container. The inner surface of the thread of the lid may be the radially inner side of the fitting flange. The radially inner side of the fitting flange may be configured to engage or mate with a container, in particular with a corresponding thread of the container, in particular on an outer surface of the container.

The container may define a receptacle. The fitting flange of the paper lid may be adapted to be arranged on the receptacle of the container.

The container may comprise a circumferential side wall. The side wall may define an outer surface of the container, in particular the outer surface with a thread. The thread may be formed on top of the outer surface of the container, in particular the side wall of the container. The thread may be formed, in particular carved, into the outer surface of the container, in particular into the side wall of the container.

The lid and the container may be formed out of the same material. The lid and the container may be formed out of different materials.

The container may comprise a receptacle. The receptacle may be made of glass. The receptacle may comprise paper material. The receptacle may comprise cardboard material. The receptacle may comprise plastic material. The receptacle may comprise plurilaminate material. The receptacle may comprise polylaminate material. The plurilaminate material or the polylaminate material may comprise multiple layers of material. The multiple layers of material may comprise paper material. The multiple layers of material may comprise plastic material or polyethylene. The multiple layers of material may comprise paper material and plastic material or paper material and polyethylene. The plurilaminate material or the polylaminate material may be a paper-based composite material. The plurilaminate material or the polylaminate material may be adapted to form a liquid-tight receptacle or a receptacle for food.

The container may be made of paper material. The paper material of the container may be laminated with polyethylene. The paper material of the container may be laminated with polyethylene terephthalate. The paper material of the container may be laminated with polylactide. The paper material of the container may be laminated with polypropylene.

The container may be stackable. Two containers of the same kind may fit into each other. Two containers of the same kind may be stackable into each other.

### BRIEF DESCRIPTION OF THE DRAWINGS

Exemplary embodiments will now be further described with reference to the figures in which:

FIG. 1 shows a representation of a container with a paper lid;

FIG. 2 shows a cross-section of the paper lid taken along the line A-A in FIG. 1.

FIG. 3 shows a magnifying view of a fitting flange part of the paper lid of FIG. 2.

FIG. 4 shows a cross-section of a paper lid and the bottom of a container arranged thereon.

### DETAILED DESCRIPTION

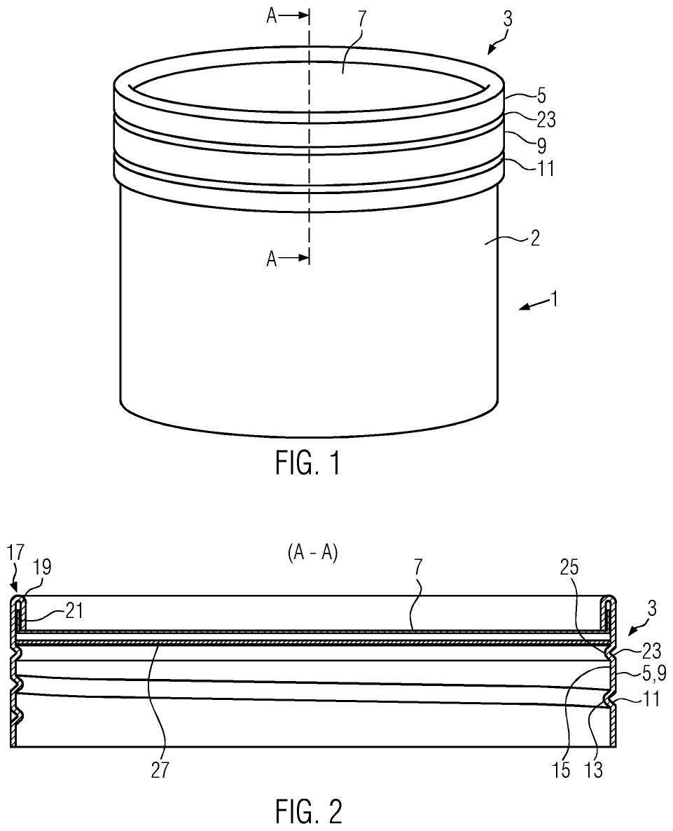

FIG. 1 shows a container 1 comprising a receptacle 2 closed by a paper lid 3. The receptacle 2 may be formed of glass material, paper material or plastic material. The paper lid 3 comprises a fitting flange 5 and a central lid panel 7. The fitting flange 5 and the central lid panel 7 may comprise paper material and are preferably made entirely of paper material. In the radially outer side 9 of the fitting flange 5, a groove 11 is formed.

FIG. 2 depicts that the groove 11 forms a thread 13 on the radially inner side 15 of the fitting flange 5. An upper portion 17 of the fitting flange 5 forms a folded portion 19. The folded portion 19 is adapted to receive an upwardly folded flange 21 of the central lid panel 7. An upper circumferential groove 23 is formed in the radially outer side 9 of the fitting flange 5. The upper circumferential groove 23 forms a circumferential protrusion 25 on the radially inner side 15 of the fitting flange 5. An insert panel 27 is arranged on the circumferential protrusion 25.

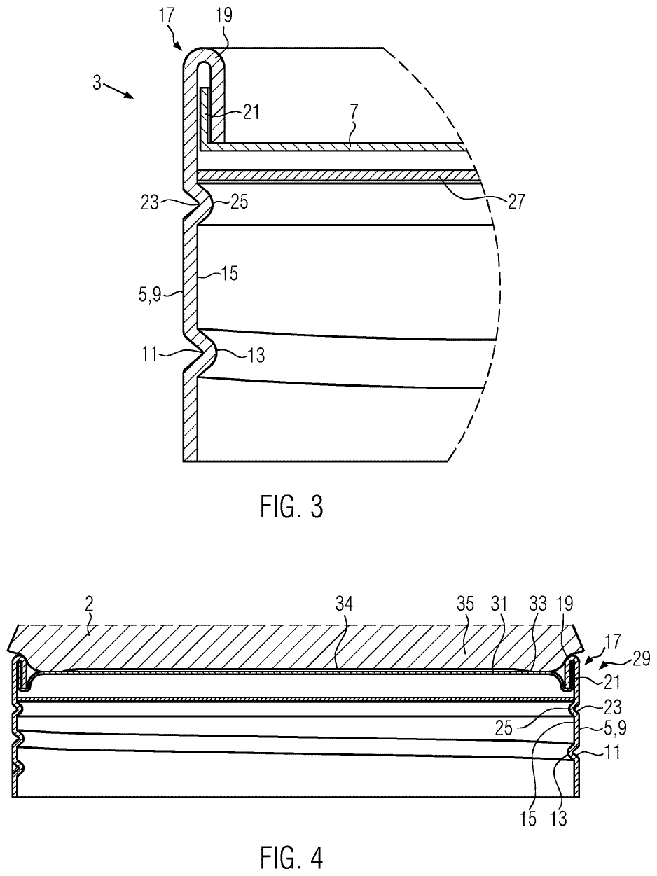

FIG. 3 depicts a magnifying view of the upper portion 17 of the fitting flange 5, receiving the upwardly folded flange 21 of the central lid panel 7.

FIG. 4 shows a paper lid 29 with a central lid panel 31. The central lid panel 31 has a stacking portion 33. The stacking portion 33 is bulged in an upper direction. A bottom 34 of a receptacle of an upper container 35 (only shown partly in FIG. 4) is arranged on the stacking portion 33. The bottom 34 of the upper container 35 is substantially flat. The bottom 34 of the upper container 35 may only sit partly on the stacking portion 33, as shown in FIG. 4. The paper lid 29, like the paper lid 3, is adapted to close the receptacle 2 of the container 1 shown in FIG. 1. The paper lid 29 provides to form a stack of at least two containers, namely container 1 and the upper container 35, wherein the receptacle 2 of container 1 is not shown in FIG. 4. The advantage of the stacking portion 33 of the paper lid 29 is to provide a wiggly-free support for at least the upper container 35, while still enabling sufficient length of the flange 21, to ensure a reliable connection in between the central lid panel 7, 31 and the folded portion 19.

The central lid panel 31 may comprise paper material and is preferably made entirely of paper material.

1.-15. (canceled)

16. A paper lid, comprising:
a central lid panel, and
a fitting flange;
wherein the fitting flange is adapted to be arranged on a receptacle of a container, the fitting flange is made of a spirally wound paper material, the fitting flange forms a radially outer side of the paper lid, a groove is formed in the radially outer side of the fitting flange, and the groove forms a thread on a radially inner side of the fitting flange.

17. The paper lid according to claim 16, wherein an upper portion of the fitting flange is connected to the central lid panel via an adhesive.

18. The paper lid according to claim 16, wherein the fitting flange has a constant thickness.

19. The paper lid according to claim 16, wherein the fitting flange has a thickness in a range of 0.5 millimeters to 1.2 millimeters.

20. The paper lid according claim 16, wherein a thickness of the central lid panel is different than the thickness of the fitting flange.

21. The paper lid according to claim 16, wherein an upper portion of the fitting flange forms a folded portion, and the folded portion receives an upwardly folded flange of the central lid panel.

22. The paper lid according to claim 16, wherein the central lid panel and the fitting flange are integrally made from a same sheet of paper material.

23. The paper lid according to claim 16, wherein the spirally wound paper material of the fitting flange is laminated with polyethylene, polyethylene terephthalate, polylactide, or polypropylene.

24. The paper lid according to claim 16, wherein an upper circumferential groove is formed in the radially outer side of the fitting flange, the upper circumferential groove forms a circumferential protrusion on a radially inner side of the fitting flange, and an insert panel is arranged on the circumferential protrusion.

25. The paper lid according to claim 16, wherein the central lid panel has a stacking portion bulged in an upper direction, and the stacking portion is disposed beneath an upper portion of the fitting flange.

26. A container comprising:
a receptacle comprised of glass or paper material or cardboard material or plastic material or plurilaminate material, or polylaminate material, and
a paper lid according to claim 16.

27. A stack of at least two containers, each of the at least two containers having a paper lid according to claim 16, wherein a bottom of an upper container is arranged on a stacking portion of a paper lid of the lower container.

28. A method for producing a lid for a container, comprising:
providing a tube of spirally wound paper material,
cutting the tube into ring-shaped segments,
connecting a ring-shaped segment with a central lid panel,
forming a thread in the ring-shaped segment.

29. The method according to claim 28, including forming a circumferential groove in the ring-shaped segment, in a separate step from forming the thread in the ring-shaped segment.

30. The method according to claim 28, including forming a stacking portion in the central lid panel, wherein the stacking portion is bulged in an upper direction.

31. A paper lid, comprising:
a central lid panel, and
a fitting flange;
wherein the fitting flange is adapted to be arranged on a receptacle of a container, the fitting flange is made of paper material, the fitting flange forms a radially outer side of the paper lid, a groove is formed in the radially outer side of the fitting flange, and the groove forms a thread on a radially inner side of the fitting flange;
wherein the central lid panel has a stacking portion, bulged in an upper direction; and
wherein the stacking portion is disposed beneath an upper portion of the fitting flange.
